(19) United States
(12) Patent Application Publication
(10) Pub. No.: US 2004/0093597 A1
(43) Pub. Date: May 13, 2004

(54) Firmware update system for facilitating firmware update in mobile handset related applications

(76) Inventors: Bindu Rama Rao, Laguna Niguel, CA (US); Iyad Qumei, Huntington Beach, CA (US)

Correspondence Address: MCANDREWS HELD & MALLOY, LTD, 500 WEST MADISON STREET, SUITE 3400, CHICAGO, IL, 60661

(21) Appl. No.: 10/701,848

(22) Filed: Nov. 5, 2003

Related U.S. Application Data
(60) Provisional application No. 60/424,041, filed on Nov. 5, 2002.

(51) Int. Cl. G06F 9/44

(52) U.S. Cl. 717/171; 717/170

(57) ABSTRACT

A firmware update system comprising a loader module, an update agent, a secure loader manager, an update package reference, a setting service and a memory manager facilitates the download of update packages and subsequent update of firmware/software in mobile handsets. In one embodiment, the secure loader manager populates the update package reference with the appropriate information and flags, employing the setting service, after the successful download and verification of an update package. In another embodiment, an update driver is employed by the mobile handset to communicate information about a downloaded update package to the update agent for subsequent firmware update.

This patent application makes reference to, claims priority to and claims benefit from U.S. Provisional Patent Application Serial No. 60/424,041, entitled “Firmware Update System for Facilitating Firmware Update in Mobile Handset,” filed on Nov. 5, 2002.

The complete subject matter of the above-referenced United States Provisional Patent Application is hereby incorporated herein by reference, in its entirety. In addition, this application makes reference to U.S. Provisional Patent Application Serial No. 60/401,054, entitled “Network for Updating Firmware,” filed Aug. 5, 2002, U.S. Provisional Patent Application Serial No. 60/249,606, entitled “System and Method for Updating and Distributing Information,” filed Nov. 17, 2000, and International Patent Application Publication No. WO 02/41147 A1, entitled “Systems And Methods For Updating And Distributing Information,” publication date Mar. 23, 2002, the complete subject matter of each of which is hereby incorporated herein by reference, in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Electronic devices, such as mobile phones and personal digital assistants (PDA's), often contain firmware and application software that are either provided by the manufacturers of the electronic devices, by telecommunication carriers, or by third parties. These firmware and application software often contain software bugs. New versions of the firmware and software are periodically released to fix the bugs or to introduce new features, or both.

Problems may arise when supporting firmware updates in devices that contain file systems. For example, the location of information stored in such a file system often needs to be communicated to low level drivers or firmware components that need to access such information before any operating system services such as, for example, file systems, are available. There may also be a need to communicate status information to low-level drivers or firmware components before the operating system services that support such communication are available, for example, during power up or reboot.

Further limitations and disadvantages of conventional and traditional approaches will become apparent to one of ordinary skill in the art through comparison of such systems with the present invention.

### BRIEF SUMMARY OF THE INVENTION

Aspects of the present invention may be seen in a system that facilitates updating of firmware in an electronic device with a file system, the system comprising an electronic device. The electronic device comprises a memory having at least one of volatile and non-volatile memory; loader software that supports a plurality of loaders; update software that supports retrieving information for updating firmware in the electronic device; and communication software that administers communicating the information for updating firmware from a server.

The update software of the electronic device comprises loading software that retrieves updating information from the server; updating software that applies the retrieved information for updating firmware in the electronic device; security software that supports secure communication between the server and the electronic device; setting software that sets values of data to indicate information about the information for updating firmware; and memory management software that manages accessing and manipulating information in the memory.

In an embodiment of the present invention, the update software further comprises a reference comprising at least one parameter related to the information for updating firmware.

A method for updating firmware in an electronic device with a file system, comprises downloading information for updating firmware in the electronic device from a server; saving the downloaded information for updating firmware in the file system; storing the location in the file system of the saved information for updating firmware to a memory reference; and determining whether the firmware needs to be updated when the electronic device reboots.

If it is determined that the firmware does not need updating, the method further comprises a normal start up of the electronic device.

If it is determined that the firmware does need updating, the method further comprises retrieving the reference to the information for updating firmware from the memory; updating the firmware using the information for updating firmware; communicating a confirmation of the updating of the firmware to the server; testing the updated firmware for errors; and communicating any errors found to the server.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1 illustrates a block diagram of an exemplary client-server environment, in accordance with an embodiment of the present invention.

FIG. 2A illustrates a block diagram of an exemplary mobile handset with a file system, in accordance with an embodiment of the present invention.

FIG. 2B illustrates a block diagram of an exemplary mobile handset with a file system, in accordance with an embodiment of the present invention.

FIG. 3 illustrates a flow diagram of an exemplary method of operating a mobile handset with a file system, in accordance with an embodiment of the present invention.

FIG. 4 illustrates a block diagram of an exemplary update driver, in accordance with an embodiment of the present invention.

### DETAILED DESCRIPTION OF THE INVENTION

The present invention relates generally to update of firmware from one version to another in mobile handsets and other constrained devices, especially those with file systems. Although the following discusses aspects of the invention in terms of a mobile handset, it should be clear that the following discussion also applies to other mobile electronic devices such as, for example, personal digital assistants (PDAs), pagers, personal computers (PCs), and similar handheld electronic devices.

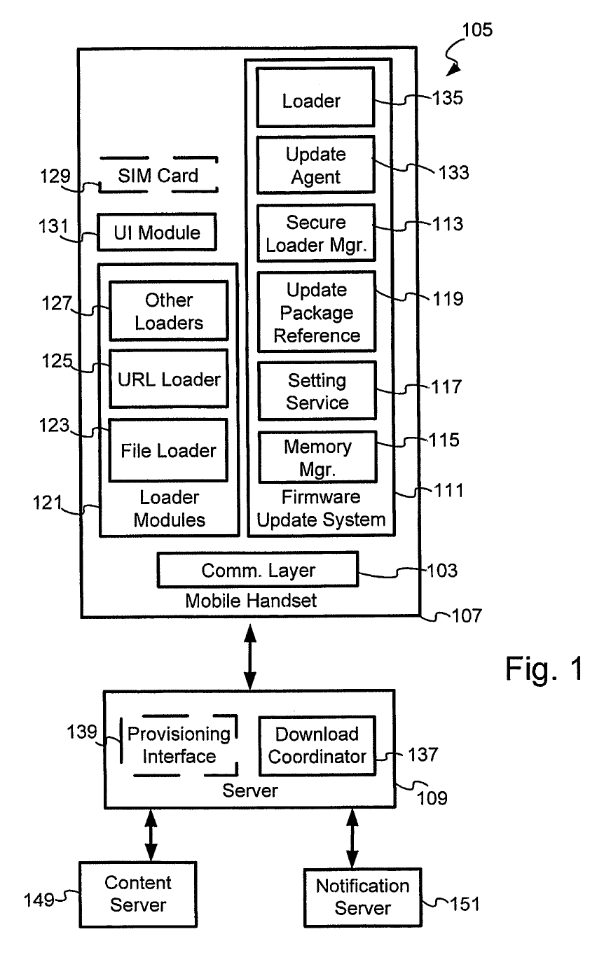

FIG. 1 illustrates a block diagram of an exemplary client-server environment 105, in accordance with an embodiment of the present invention. In the client-server environment 105, a firmware update system 111, for facilitating firmware updates in a mobile handset 107, may provide support for retrieving firmware updates from a server 109. The server 109 may comprise a download coordinator 137. The server may also comprise a provisioning interface 139. The server 109 may communicate with a notification server 151 and/or with a content server 149.

The firmware update system 111 may apply the firmware updates, retrieved from the server 109, to the mobile handset 107. The mobile handset 107 may comprise the firmware update system 111, loader modules 121, a user interface (UI) module 131, and a communication layer 103. In an embodiment of the present invention, the mobile handset 107 may also comprise a subscriber identity module (SIM) card 129.

In an embodiment of the present invention, the firmware update system 111 may comprise a loader 135, an update agent 133, a secure loader manager 113, an update package reference 119, a setting service 117, and a memory manager 115. The loader modules 121 may support a plurality of loaders such as a file loader 123, a uniform resource locator (URL) loader 125, or other loaders 127. These loader modules 121 may facilitate loading or retrieving of data or files into the mobile handset 107 for display or for processing. The secure loader manager 113 may employ the loader 135 or one of the loader modules 121 to retrieve (load) an update package from an external system such as, for example, the server 109, or from a local file system in the mobile handset 107.

In an embodiment of the present invention, the secure loader manager 113 may facilitate secure downloads of update packages and other information from external systems such as the server 109. The secure loader manager 113 may manage the secure communication of parameters such as, for example, the manufacturer's identification, model information, and version numbers, to the server 109. The secure loader manager 113 may employ appropriate message formats and commands and incorporate appropriate security mechanisms during communication. The secure loader manager 113 may also coordinate the verification of authenticity of received information and its storage in the mobile handset 107. In an embodiment of the present invention, the secure loader manger 113 may coordinate the setting of various flags and status information in the mobile handset 107 employing the setting service 117. Following successful download and verification of an update package for updating firmware, the secure loader manager 113 may employ the setting service 117 to set a flag or change an indicator and/or other related information such as, for example, cyclic redundancy check (CRC) values, etc. The set flag or the changed indicator may indicate the need to update the firmware of the mobile handset 107 employing the update agent 133 when the mobile handset 107 is next restarted or power cycled.

In an embodiment of the present invention, the secure loader manager 113 may employ the setting service 117 to set the values of parameters in the update package reference 119. In an embodiment of the present invention, the update package reference 119 may be, for example, a 16-byte section of memory that the update agent 133 is capable of accessing and reading. The update package reference 119 may comprise parameters such as, for example, a 4-byte state flag (e.g., on/off flags), an address referencing the downloaded update package, an address referencing a backup section, and a 4-byte CRC value based on the 16-byte flag sections and the two addresses. The update agent 133 may read the 16-byte update package reference 119 when the mobile handset 107 is restarted or rebooted to determine the need to update the firmware of the mobile handset 107.

In an embodiment of the present invention, the firmware update system 111 may employ a URL loader 125 to download an update package from the server 109. The URL loader 125 may use either an absolute or a relative URL to identify the update package. In another embodiment of the present invention, the firmware update system 111 may employ the loader module 135 to download an update package from the server 109. In such embodiments, the secure loader manager 113 may provide the update package reference 119 with the appropriate information and flags, employing the setting service 117 following a successful download and verification of an update package.

In an embodiment of the present invention, the memory manager 115 may provide support for accessing and manipulating some components of volatile and/or non-volatile memory. The loader 135 and the loader modules 121 may employ the memory manager 115 to save information, retrieve information, manipulate information, delete information, etc., in volatile and/or non-volatile memory. The update agent 133 may employ the memory manager 115 to access, manipulate and/or modify the data in volatile and/or non-volatile memory.

In devices containing file systems, such as the mobile handset 107 of the present invention, supporting firmware updates may require communicating the location of update packages to low level drivers or communicating firmware components that need to access the update packages before any operating system services are available. In an embodiment of the present invention, the update package reference 119 may provide a mechanism by which the location of an update package is communicated to the update agent 133.

In devices containing file systems, such as the mobile handset 107 of the present invention, supporting firmware updates may also require communicating status information to low-level drivers or firmware components to determine whether a firmware update is needed. In an embodiment of the present invention, the update package reference 119 may provide the means to communicate the status information and/or the firmware components to determine whether a firmware update is needed.

In an embodiment of the present invention, the setting service 117 may be a low-level function in the firmware. In such an embodiment, the setting service 117 may interact with the memory manager 115 to set the values of data in the update package reference 119 when instructed to do so by the secure loader manager 113. The update agent 133, which may be part of the firmware of the mobile handset 107, may access data in the update package reference 119. In another embodiment of the present invention, the update agent 133 may interact with the memory manager 115 to access volatile and/or non-volatile memory.

In another embodiment of the present invention, the setting service 117 may be a function available to the secure loader manager 113 and other application-level functions, which can interact with the memory manager 115 to set the values of data in the update package reference 119. In such an embodiment, the secure loader manager 113 may instruct the application-level function setting service 117 to set the values of the 4-byte status flag, the 4-byte update package address, a 4-byte backup address and a 4-byte CRC value in the update package reference 119. In response, the setting service 117 may employ the low-level memory manager 115 module, or some other module provided by the firmware, to set the values of the update package reference 119.

In an embodiment of the present invention, memory in the mobile handset 107, and in particular, the update package reference 119, may be accessed and manipulated via the memory manager 115. In such an embodiment, the setting service 117 may employ the memory manager 115 to set values into the update package reference 119 at the request of the secure loader manager 113. The update agent 133 may also employ the memory manager 115 to access memory in general, and the update package reference 119 in particular.

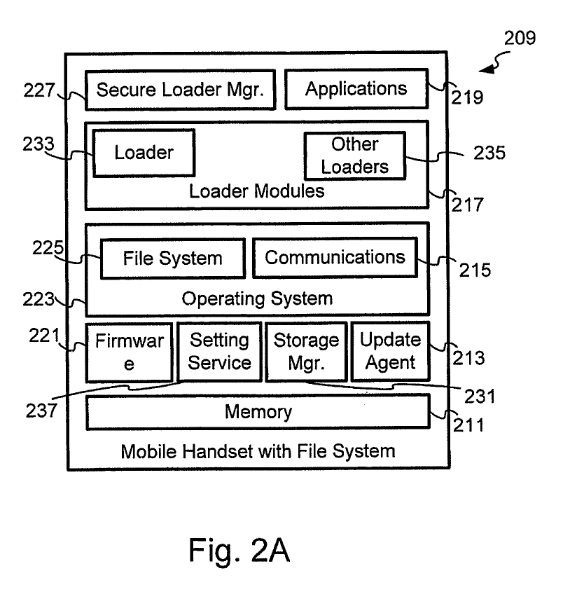

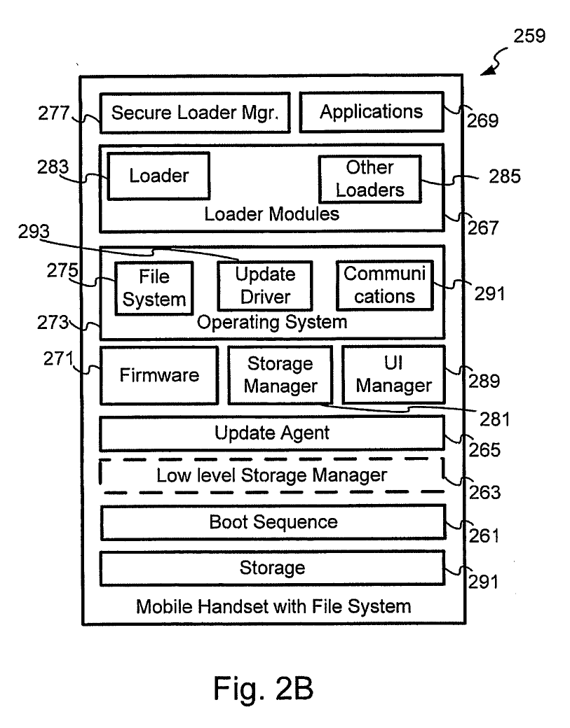

FIG. 2A illustrates a block diagram of an exemplary mobile handset 209 with a file system, in accordance with an embodiment of the present invention. In the mobile handset 209, a secure loader manager 227, and an update agent 213, may facilitate the update of firmware 221. The mobile handset 209 may comprise a memory (e.g. volatile and/or non-volatile) 211, firmware 221, a setting service 237, a storage manager 231, an update agent 213, an operating system 223, loader modules 217, a secure loader manager 227, and applications 219. The operating system 223 may comprise a file system 225 and communications modules 215. The loader modules 217 may comprise a loader 233 and other loaders 235.

In an embodiment of the present invention, the secure loader manager 227 may facilitate the updating of firmware in the mobile handset 209. The secure loader manager 227 may support retrieving firmware updates as update packages from an external server such as, for example, the server 109 of FIG. 1, and applying the updates to the firmware 221 in the mobile handset 209 employing the update agent 213. The update agent 213 may be used to update applications, configuration parameters, etc., in addition to firmware 221.

In an embodiment of the present invention, a download mechanism may be identified, in association with the server, to identify appropriate update packages for the specific device type. In addition, the use of an appropriate transport mechanism may be negotiated with the server.

In a mobile handset 209, the update agent 213 may need to determine the storage location of update packages for access during startup. The update agent 213 may operate independently from both the operating system 223 and the proprietary operating system of the mobile handset 209. In such an embodiment, communicating the location of an update package to the update agent 213 may be accomplished using a specific type of device driver for the operating system 223, to directly access the memory 211 such as, for example, flash memory. In this embodiment, a separate device driver may be used to retrieve the location of the update package in the memory 211.

In an embodiment of the present invention, space may be allocated in the memory 211 for downloaded update packages. The allocated space may be beyond the control of the operating system 223. In such an embodiment, it may be necessary to ensure that the file system 225 of the operating system 223 does not also employ the space allocated for the downloaded update packages.

In another embodiment of the present invention, a downloaded update package may be stored in a section of memory allocated for user data. In such an embodiment, the secure loader manager 227 may employ the storage manager 231 to allocate space for user data, for the update package, and may save a reference to it by employing the setting service 237. The setting service 237 may save the reference to the update package in the update package reference. The update agent 213 may have read-write access to the update package reference such as, for example, the update package reference 119 of FIG. 1.

In an embodiment of the present invention, the update package reference may be populated with information regarding the location of the update package (and other related information). The update package reference may be stored in a default location that is accessible by the update agent 213. In another embodiment of the present invention, a function may be provided to the update agent 213. The function may be used to retrieve the location of the update package reference and return it to the update agent 213 at runtime.

In an embodiment of the present invention, the secure loader manager 227 may store the update package in non-volatile memory, employing the storage manager 231. The secure load manager 227 may also save the update package reference in a SIM card employing the setting service 237 and appropriate SIM card drivers (not shown). The update agent 213 may then read the update package reference from the SIM card during startup.

In an embodiment of the present invention, information regarding the location where an update package is stored may be stored within the user data section of memory. An interface may be provided to allow access to the OS file system. Tools may also be made available to identify the update package and provide information indicating the location of the update package in memory 211 such as, for example, non-volatile memory.

In an embodiment of the present invention, the setting service 237 may be located above the operating system 223, i.e. as a component that executes on top of the operating system. The setting service 237 may interact with the storage manager 231 to set values of parameters in the update package reference, for example, a CRC value, an address of the downloaded update package, an address of the backup area, flags indicating the need to update firmware/software, etc.

FIG. 2B illustrates a block diagram of an exemplary mobile handset 259, in accordance with an embodiment of the present invention. In the mobile handset 259, a secure loader manager 277 with loader modules 267, and an update agent 265, may facilitate the update of firmware 271. In an embodiment of the present invention, the mobile handset 259 may comprise a storage (e.g. volatile and/or non-volatile memory) 291, a boot sequence 261, firmware 271, a storage manager 281, a user interface (UI) manager 289, an update agent 265, an operating system 273, loader modules 267, a secure loader manager 277, and applications 269. In an embodiment of the present invention, the mobile handset 259 may also comprise a low-level storage manager 263. The operating system 273 may comprise a file system 275, an update diver 293, and communications modules 291. The loader modules 267 may comprise a loader 283 and other loaders 285.

In an embodiment of the present invention, the secure loader manager 277 may facilitate updating of firmware in the mobile handset 259. The secure loader manager 277 may support retrieving firmware updates as update packages from an external server and applying them to the firmware 271 in the mobile handset 259 employing the update agent 265. The update agent 265 may be used to update applications 269, configuration parameters, etc., in addition to firmware 271.

In an embodiment of the present invention, the secure loader manager 277 may employ one of the loader modules 267 to download an update package from an external system such as, for example, a device server, or a delivery server. The secure loader manager 277 may employ identifying characteristics of the mobile handset 259 such as, for example, the manufacturer, the model, the source firmware/software version, the target firmware/software version, etc. The secure loader manager 277 may store information about the downloaded update package in a section of storage 291 called an update package reference, employing the services provided by the file system 275 and/or the storage manager 281. This section of storage 291 may correspond, for example, to the update package reference 119 of FIG. 1. In such an embodiment, a change indicator, indicating the availability of an update package, may be set in the update package reference. The change indicator may then be employed by the update agent 265 to determine when to apply the firmware update during reboot or power up. In an embodiment of the present invention, the change indicator may be, for example, a 4-byte (or an integer) state flag that indicates ON/OFF.

In an embodiment of the present invention, the secure loader manager 277 may employ one of the loader modules 267 to download an update package from an external system. The secure loader manager 277 may then employ the update driver 293 to save the downloaded updated package and may retrieve information about the downloaded update package. The secure loader manager 277 may then save the retrieved information in an update package reference such as, for example, the update package reference 119 of FIG. 1, and set a change indicator flag in the update package reference to indicate the availability of an update package. In an embodiment of the present invention, the update driver 293 may employ the storage manager 281 to store the update package and retrieve information on where and how it is stored. The update driver 293 may store the update package reference in storage 291. The update driver 293 may also set the change indicator, i.e., set flags to indicate availability of an update package.

In an embodiment of the present invention, the update driver 293 may provide a function to allocate sufficient space in storage 291 for storing an update package. The update driver 293 may also provide a function to save an update package by employing the storage manager 281. The function may return information on where the update package is stored. The update driver 293 may also provide a function to save, for example, the values of a CRC for the update package, the address of the update package in storage 291, the address of a backup section in storage 291, the flags of a change indicator, etc., in the update package reference in storage 291. In another embodiment of the present invention, the update driver 293 may provide a function to save the update package reference in a SIM card associated with the mobile handset 259. The function may employ a SIM card driver provided by the firmware 271 or by the operating system 273. The update driver 293 may also provide a function to power down the mobile handset 259 when invoked, then power it up, i.e. invoke a power cycle, to update the firmware 271, device drivers or applications 269. The secure loader manager 277 may employ the functions provided by the update driver 293 to save update packages and to set values in the update package reference in storage 291 before causing the execution of the update agent 265, after a reboot. The secure loader manager 277 may employ the services of the update driver 293 that behaves as a device driver capable of saving large content in a file system while saving specific information, in specific locations of the non-volatile memory of the mobile handset, regarding the saved large content.

In an embodiment of the present invention, the update agent 265 may take control after the initial execution of the boot sequence 261 following power up or reboot. The update agent 265 may access the update package reference in storage 291 by employing the low-level storage manager 263, to determine whether a firmware update should be applied. A change indicator may be employed to make that determination. When set to ON, the change indicator may indicate that an update, such as a firmware or an application software update, is necessary. If the update agent 265 determines that an update is necessary, it may execute the update process employing the update package. A reference to the update package may be retrieved from the update package reference. During the update process, the update agent 265 may also verify the authenticity of the update package and its subcomponents. After the execution of the update and before rebooting the mobile handset 259, the update agent 265 may reset the change indicator to indicate the performance was successfully performed. During the execution of the boot sequence 261, if the update agent 265 determines that an update is not necessary, the update agent 265 may pass control to the normal execution of the firmware 271.

In an embodiment of the present invention, the change indicator may support two sets of flags or change indicators. One set of change indicators may indicate the need to update one or more software components or modules that subsequently do not require a reboot. Another set of change indicators may indicate the need to update components in the firmware, device drivers or software components that subsequently require a reboot.

In an embodiment of the present invention, the update package reference may be, for example, a 16-byte section of storage 291. The update package reference may comprise a change indicator (for example, a 4-byte change indicator) that supports two sets of flags, one set to indicate the need to update one or more software components or modules that subsequently do not require a reboot, and another set of flags to indicate the need to update components in the firmware, device drivers or software components that subsequently do require a reboot. The change indicator may be monitored by a low-level monitor (thread or process) that periodically checks to see if an update, with or without reboot, is needed. If a reboot is needed, the low-level monitor may ensure, before initiating a power cycle, that there are no other threads or processes that are negatively impacted by the reboot. The periodic check by the low-level monitor may employ timer-based monitoring in a related embodiment.

In an embodiment of the present invention, the storage manager 281 may incorporate the low-level storage manager 263. In another embodiment of the present invention, the update agent 265 may incorporate the boot sequence 261. In yet another embodiment of the present invention, the firmware 271 may incorporate the boot sequence 261. In still another embodiment of the present invention, the file system 275 may incorporate the storage manager 281.

In an embodiment of the present invention, an appropriate download mechanism may be identified, in association with an external server, for example server 109 of FIG. 1, to identify appropriate update packages for the specific device type. The use of the appropriate transport mechanism may be negotiated with the server.

In an embodiment of the present invention, the update driver 293 may employ the services of the firmware 271, the storage manager 281, and the UI manager 289 to support the storage and retrieval of an update package and related information. In another embodiment of the present invention, the update driver 293 may also employ services provided by the file system 275 and communications 291.

In an embodiment of the present invention, the secure loader manager 277 may employ one of the other loaders 285 (such as a URL loader) to retrieve an update package. The URL loader may employ the communications module 291 for data transport and security. The secure loader manager 277 may then employ the update driver 293 to save the update package. The update driver 293 may in turn employ the file system 275 to save the downloaded update package in the file system provided by the operating system 273. The update driver 293 may store a placement layout table with table entries for various storage segments occupied by the saved update package. The storage segments may be expressed in terms of, for example, banks, sectors, sector blocks, etc., for non-volatile memory such as FLASH. The placement layout table may be stored in storage 291, and its address may be saved in an update package reference along with, for example, CRC values, flags, a backup segment address, etc. On reboot, the update agent 265 may retrieve a reference for the placement layout table from the update package reference, may retrieve the placement layout table, and may access the update package to update the firmware.

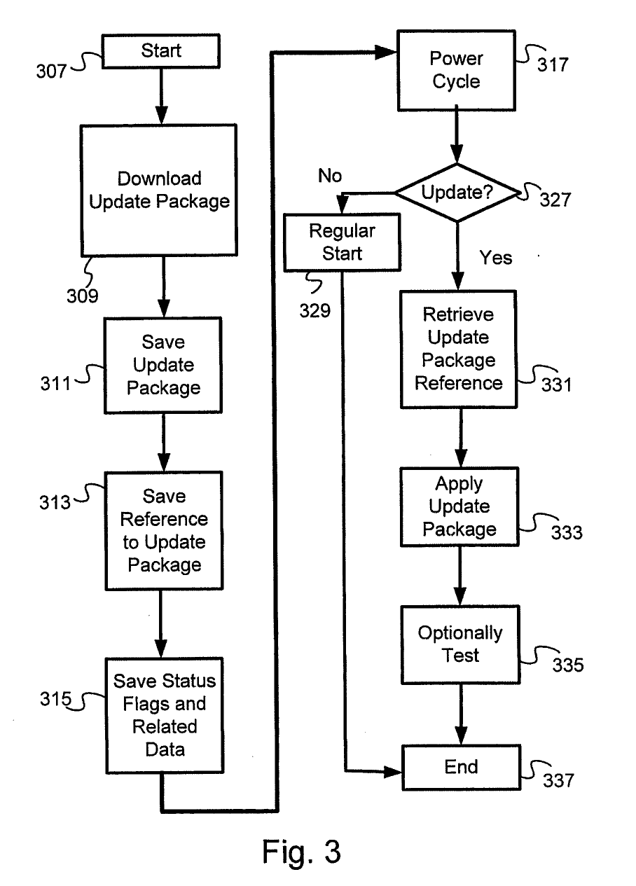

FIG. 3 illustrates a flow diagram of an exemplary method of operating a mobile handset with a file system, such as mobile handset 259 of FIG. 2B, for example, in accordance with an embodiment of the present invention. In an embodiment of the present invention, a downloaded update package may be saved in storage with an update package reference set appropriately to refer to the update package. At a block 307, processing starts when the mobile handset is notified by an external system to update its firmware/software, or when the user initiates a firmware/software download. At the next block 309, the update package may be downloaded employing appropriate data transport protocols. At the next block 311, the update package may be saved and its location in the file system may be retrieved for populating an update package reference. At a next block 313, the location of the update package in the file system may be saved in an update package reference in storage. The update package reference may be located in a segment of storage accessible by an update agent.

In an embodiment of the present invention, a mobile client such as, for example, the update driver 293 of FIG. 2B, may assemble a placement layout table for the update package when the update package reference is to be saved. The placement layout table for the update package may map segments of the update package, which may be spread over one or more banks or sectors of storage. The placement layout table, or a reference to it, may be saved in the update package reference.

At a next block 315, the update package reference may be populated with CRC information, an address of a backup segment of memory, flags, etc. that facilitate the update process. Then, a power cycle at a block 317 may cause the transition to the update process.

During a subsequent reboot process, at a next block 327, a determination may be made of whether a firmware/software update is to be executed. If it is determined that an update is not necessary, then a normal reboot operation may be conducted at a next block 329 before the update processing terminates at an end block 337. However, if, at block 327, it is determined that an update is necessary, then the update agent may retrieve the update package reference and verify the authenticity of the update package at a next block 331. Then, at a next block 333, the update agent may apply the update package to the firmware/software.

Later, at a next block 335, the update firmware may be tested and if any errors are encountered, they are saved or communicated to an external system. The update process may end at block 337, where a confirmation of the update may be communicated to one or more external systems.

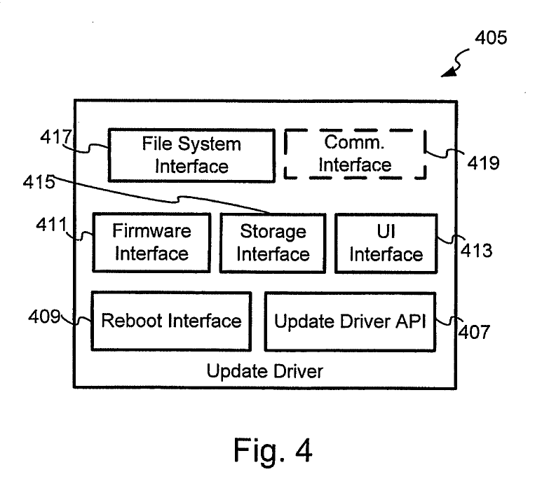

FIG. 4 illustrates a block diagram of an exemplary update driver 405, in accordance with an embodiment of the present invention. The update driver 405 may be employed by a mobile handset with a file system, which may correspond to mobile handset 259 of FIG. 2B, for example, to communicate information about a downloaded update package to an update agent for a subsequent firmware update. In an embodiment of the present invention, the update driver 405 may comprise a reboot interface 409, an update driver API 407, a firmware interface 411, a storage interface 415, a UI interface 413, and a file system interface 417. The reboot interface 409 may facilitate initiating a reboot of the mobile handset. The update driver API 407 may facilitate saving and retrieving update packages and information related to update packages such as, for example, CRC, addresses, placement layout table in file systems, etc. The firmware interface 411 may be used to invoke firmware features and services. The storage interface 415 may enhance interaction with storage managers such as, for example, a FLASH manager. The UI interface 413 may be used to invoke user input and provide user feedback. The file system interface 417 may facilitate saving information employing the file system and retrieving information about update packages stored in the file system.

In another embodiment of the present invention, the update driver 405 may also comprise a communication interface 419. The communication interface 419 may facilitate interactions with external systems employing a data transport protocol.

In an embodiment of the present invention, an update agent such as update agent 265 of FIG. 2B may employ the update driver 405 to determine the location of an update package reference, in order to access the update package. The update driver 405 may store update packages and update package related information in the update package reference, and may return the address or location of the saved update package reference to the update agent.

In an embodiment of the present invention, an update agent may retrieve an update package reference from a default location in storage, where an update driver may have previously populated the update package reference with appropriate values after the download of an update package.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system that facilitates updating of firmware in an electronic device with a file system, the system comprising:
an electronic device comprising:
at least one of volatile and non-volatile memory;
loader software that supports a plurality of loaders;
update software that supports retrieving information for updating firmware in the electronic device; and
communication software that administers communicating the information for updating firmware from a server.

2. The system according to claim 1 wherein the system further comprises a driver software that communicates, to the updating software, information about retrieved information for updating firmware in the electronic device.

3. The system according to claim 1 wherein the server is an external system.

4. The system according to claim 1 wherein the server is a local file system.

5. The system according to claim 1 wherein the update software comprises:
loading software that retrieves updating information from the server;
updating software that applies the retrieved information for updating firmware in the electronic device;
security software that supports secure communication between the server and the electronic device;
setting software that sets values of data to indicate information about the information for updating firmware; and
memory management software that manages accessing and manipulating information in the memory.

6. The system according to claim 5 wherein the update software further comprises a reference comprising at least one parameter related to the information for updating firmware.

7. The system according to claim 6 wherein the at least one parameter comprises a 4-byte state flag.

8. The system according to claim 6 wherein the at least one parameter comprises an address referencing the information for updating firmware.

9. The system according to claim 6 wherein the at least one parameter comprises an address referencing a backup section.

10. The system according to claim 6 wherein the at least one parameter comprises a 4-byte CRC value.

11. The system according to claim 5 wherein the security software controls information in the electronic device, wherein the information indicates whether the firmware in the electronic device needs updating.

12. The system according to claim 6 wherein the security software utilizes the setting software to set the value of the at least one parameter.

13. The system according to claim 6 wherein the updating software uses the reference to determine whether the firmware in the electronic device needs updating.

14. The system according to claim 6 wherein the updating software uses the reference to determine the location of the information for updating firmware.

15. The system according to claim 1 wherein the update software utilizes a uniform resource locator (URL) to download information for updating firmware from the server.

16. A method for updating firmware in an electronic device with a file system, the method comprising:
downloading information for updating firmware in the electronic device from a server;
saving the downloaded information for updating firmware in the file system;
storing a location in the file system of the saved information for updating firmware to a memory reference; and
determining whether the firmware needs to be updated when the electronic device reboots.

17. The method according to claim 16 wherein, if it is determined that the firmware does not need updating, the method further comprises a normal start up of the electronic device.

18. The method according to claim 16 wherein, if it is determined that the firmware does need updating, the method further comprises:
retrieving the reference to the information for updating firmware from the memory; and
updating the firmware using the information for updating firmware.

19. The method according to claim 18 wherein the method further comprises communicating a confirmation of the updating of the firmware to the server.

20. The method according to claim 18 wherein the method further comprises testing the updated firmware for errors.

21. The method according to claim 20 wherein the method further comprises communicating any errors found to the server.

22. The method according to claim 16 wherein the electronic device retrieves status information from the information for updating firmware via the memory reference to determine whether the firmware needs to be updated using the information for updating firmware.
